(19) United States
(12) Patent Application Publication
(10) Pub. No.: US 2022/0269356 A1
(43) Pub. Date: Aug. 25, 2022

(54) WRITING FEEL IMPROVING SHEET

(71) Applicant: LINTEC CORPORATION, Tokyo (JP)

(72) Inventors: Akihira WATANABE, Tokyo (JP); Minami NAKANISHI, Tokyo (JP); Hiroki HOSHINO, Tokyo (JP)

(73) Assignee: LINTEC CORPORATION, Tokyo (JP)

(21) Appl. No.: 17/670,995

(22) Filed: Feb. 14, 2022

(30) Foreign Application Priority Data
Feb. 15, 2021 (JP) 2021-021730

(51) Int. Cl. G06F 3/039; G06F 3/0354

(52) U.S. Cl. CPC G06F 3/0393; G06F 2203/04103; G06F 3/03545

(57) ABSTRACT

A writing feel improving sheet comprising a base material and a writing feel improving layer with which a touch pen is brought into contact, wherein the writing feel improving layer contains an antiviral agent, and a number of peaks with an amplitude of 1.5 or more in a frequency range of 1 to 2 Hz is 3 or more and 20 or less.

### TECHNICAL FIELD

The present invention relates to a writing feel improving sheet having antiviral properties.

### BACKGROUND ART

In recent years, image display devices (touch panels) having a position detection function and serving both as a display device and as an input means are widely used in various electronic devices. Such touch panels include those in which the input operation is performed by a finger as well as those in which the input operation is performed by using a touch pen. The touch pen allows the input operation to be performed with a higher degree of accuracy than by a finger. Usually, however, display modules of touch panels are rigid. The writing feel with a touch pen is therefore different from the writing feel experienced when writing on paper with a pen or pencil and cannot be said to be good.

To solve the problem of writing feel with a touch pen on a touch panel, it has been considered to attach a film for improving the writing feel (which may be referred to as a “writing feel improving film” or a “writing feel improving sheet,” hereinafter) to the outermost surface of the touch panel. For example, Patent Document 1 discloses a tactile film as such a writing feel improving film. The tactile film includes a transparent substrate film and linear protrusions that form a network structure on at least one surface of the transparent substrate film. The network structure has a plurality of sections arranged regularly. The linear protrusions occupy an area of 5% to 80% with respect to the entire tactile film surface.

Incidentally, in these days, a pandemic of an infectious disease (COVID-19) of the new coronavirus (SARS-CoV-2) has occurred, which has become a serious problem worldwide. When viruses adhere to the surface of a touch panel and the surface of the touch panel is touched with a finger, the viruses may invade the human body through the finger and cause infection. It is therefore desired to impart antiviral properties to the surface of a touch panel.

Patent Documents 2 and 3 disclose non-woven fabrics, knitted fabrics, sheets, etc. having antiviral properties, but their optical applications are not considered. On the other hand, Patent Document 4 discloses an antiviral member intended to be applied to various uses.

### PRIOR ART DOCUMENTS

### Patent Documents

[Patent Document 1] JP2015-054417A
[Patent Document 2] JP5577346B
[Patent Document 3] JP5614802B
[Patent Document 4] JP6145758B

### SUMMARY OF THE INVENTION

### Problems to be Solved by the Invention

The application targets for the antiviral member of Patent Document 4 include optical applications, but it is not sufficient as a concrete study assuming the use on the outermost surface of a display device or the like.

The present invention has been made in consideration of such actual circumstances and an object of the present invention is to provide a writing feel improving sheet that is excellent in the writing feel with a touch pen and has antiviral properties.

### Means for Solving the Problems

To achieve the above object, first, the present invention provides a writing feel improving sheet comprising a base material and a writing feel improving layer with which a touch pen is brought into contact, wherein the writing feel improving layer contains an antiviral agent, and a number of peaks with an amplitude of 1.5 or more in a frequency range of 1 to 2 Hz is 3 or more and 20 or less, wherein the number of peaks is acquired from a frequency-amplitude chart that is obtained through bringing a pen tip of a hard felt core touch pen having a pen tip diameter of 0.5 mm into vertical contact with a surface of the writing feel improving layer with which the touch pen is brought into contact under a pressurization condition of a load of 3.92N, measuring a pen tip resistance force while moving the pen tip at a speed of 100 mm/min in any direction parallel to the surface of the writing feel improving layer to obtain a movement distance-pen tip resistance force chart, and Fourier transforming the obtained movement distance-pen tip resistance force chart to obtain the frequency-amplitude chart (Invention 1).

In the above invention (Invention 1), the writing feel improving layer contains an antiviral agent thereby to have antiviral properties. Moreover, the above physical properties regarding the writing feel allows the writing feel with a touch pen to be excellent.

In the above invention (Invention 1), a dynamic friction coefficient may be preferably 0.10 or more and 0.50 or less when a touch pen having a pen tip of 0.5 mm diameter is used to bring the pen tip into contact with the surface of the writing feel improving layer with which the touch pen is brought into contact and the touch pen is then linearly slid at a speed of 1.6 mm/sec while applying a load of 200 g to the touch pen and maintaining an angle formed between the touch pen and the surface of the writing feel improving layer at 45° (Invention 2).

In the above invention (Invention 1, 2), a static friction coefficient may be preferably 0.10 or more and 0.50 or less when a touch pen having a pen tip of 0.5 mm diameter is used to bring the pen tip into contact with the surface of the writing feel improving layer with which the touch pen is brought into contact and the touch pen is then linearly slid at a speed of 1.6 mm/sec while applying a load of 200 g to the touch pen and maintaining an angle formed between the touch pen and the surface of the writing feel improving layer at 45° (Invention 3).

In the above invention (Invention 1 to 3), the writing feel improving layer may be preferably a layer formed by curing a coating composition that contains a curable component and the antiviral agent (Invention 4).

In the above invention (Invention 1 to 4), the antiviral agent may be preferably an organic-based filler (Invention 5).

### Advantageous Effect of the Invention

The writing feel improving sheet according to the present invention is excellent in the writing feel with a touch pen and has antiviral properties.

### BRIEF DESCRIPTION OF DRAWINGS

FIG. 1 is a cross-sectional view of a writing feel improving sheet according to an embodiment of the present invention.

### EMBODIMENTS FOR CARRYING OUT THE INVENTION

Hereinafter, one or more embodiments of the present invention will be described.

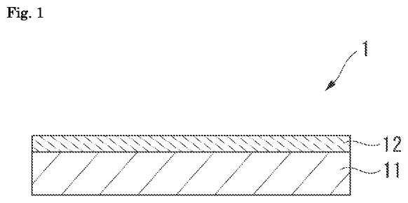

The writing feel improving sheet according to an embodiment of the present invention is a sheet that constitutes the outermost layer of a touch panel on which a touch pen is used, and includes a base material and a writing feel improving layer with which a touch pen is brought into contact. Preferably, as illustrated in FIG. 1, a writing feel improving sheet 1 according to the present embodiment may include a base material 11 and a writing feel improving layer 12 provided on one surface side of the base material 11. The writing feel improving layer 12 contains an antiviral agent.

In the writing feel improving sheet 1 according to the present embodiment, the number of peaks with an amplitude of 1.5 or more (number of amplitudes) in a frequency range of 1 to 2 Hz is preferably 3 or more and 20 or less. The number of peaks is acquired from a frequency-amplitude chart that is obtained through bringing the pen tip of a hard felt core touch pen having a pen tip diameter of 0.5 mm into vertical contact with the surface of the writing feel improving layer 12 with which the touch pen is brought into contact under a pressurization condition of a load of 3.92N, measuring a pen tip resistance force while moving the pen tip at a speed of 100 mm/min in any direction parallel to the surface of the writing feel improving layer 12 to obtain a movement distance-pen tip resistance force chart, and Fourier transforming the obtained movement distance-pen tip resistance force chart to obtain the frequency-amplitude chart (the physical properties regarding the amplitudes obtained in the above pen sliding test may be referred to as “writing feel physical properties,” hereinafter). The Fourier transformation is to be performed by using software (available from Microsoft Corporation, product name “Excel” (registered trademark)). The “pen tip resistance force” refers to a resistance force applied to the pen tip when the touch pen is moved under the above conditions.

In the writing feel improving sheet 1 according to the present embodiment, the writing feel improving layer 12 contains an antiviral agent thereby to have antiviral properties. Moreover, the writing feel improving sheet 1 has the above writing feel physical properties thereby to be excellent in the writing feel with a touch pen. The antiviral agent contained in the writing feel improving layer 12 may be usually in a form of fine particles and also has an effect of imparting the above writing feel physical properties.

In the writing feel improving sheet 1 according to the present embodiment, particularly owing to the features that the writing feel improving layer 12 contains an antiviral agent and the above number of peaks of the amplitudes is in the above range, the writing feel with a touch pen is imparted with a preferred feeling of pen tip flow and a preferred feeling of pen tip catch. Combination of these feelings allows the writing feel with a touch pen to be excellent one close to the feeling of writing on paper with a pen.

The amplitudes are defined in the frequency range of 1 to 2 Hz. This is because the present inventors have experimentally found that the characteristic vibrations which humans perceive as “writing feel” are those in the frequency range of 1 to 2 Hz when the vibration during writing is regarded as the superposition of a plurality of vibrations having various frequencies.

As the touch pen, for example, a hard felt core touch pen having a pen tip diameter of 0.1 to 5 mm, a polyacetal core touch pen, or other similar touch pen can be used, and the above effect can be obtained regardless of the touch pen to be used. Examples of a “pen” used as a reference for the writing feel in the present specification include a ballpoint pen, a felt pen, a fountain pen, and other similar pens and a fountain pen may be preferably used as the reference.

From the viewpoint of writing feel with a touch pen, the above number of peaks of the amplitudes (number of amplitudes) may be preferably 4 or more, more preferably 5 or more, particularly preferably 6 or more, and further preferably 8 or more. From the same or another viewpoint, the above number of peaks (number of amplitudes) may be preferably 18 or less, more preferably 15 or less, particularly preferably 13 or less, and further preferably 10 or less.

A specific method of acquiring the above movement distance (mm)-pen tip resistance force (mN) chart is as described in the testing example, which will be described later.

In the writing feel improving sheet 1 according to the present embodiment, when a touch pen having a pen tip of 0.5 mm diameter is used to bring the pen tip into contact with the surface of the writing feel improving layer 12 with which the touch pen is brought into contact and the touch pen is then linearly slid at a speed of 1.6 mm/sec while applying a load of 200 g to the touch pen and maintaining an angle formed between the touch pen and the surface of the writing feel improving layer 12 at 45°, the dynamic friction coefficient may be preferably 0.10 or more, more preferably 0.12 or more, particularly preferably 0.14 or more, and further preferably 0.17 or more. From another aspect, the dynamic friction coefficient may be preferably 0.50 or less, more preferably 0.40 or less, particularly preferably 0.30 or less, and further preferably 0.23 or less. When the above dynamic friction coefficient falls within the above range, the writing feel with a touch pen is more excellent.

In the writing feel improving sheet 1 according to the present embodiment, when a touch pen having a pen tip of 0.5 mm diameter is used to bring the pen tip into contact with the surface of the writing feel improving layer 12 with which the touch pen is brought into contact and the touch pen is then linearly slid at a speed of 1.6 mm/sec while applying a load of 200 g to the touch pen and maintaining an angle formed between the touch pen and the surface of the writing feel improving layer 12 at 45°, the static friction coefficient may be preferably 0.10 or more, more preferably 0.12 or more, particularly preferably 0.14 or more, and further preferably 0.18 or more. From another aspect, the static friction coefficient may be preferably 0.50 or less, more preferably 0.40 or less, particularly preferably 0.30 or less, and further preferably 0.25 or less. When the above static friction coefficient falls within the above range, the writing feel with a touch pen is more excellent.

A specific method of measuring the above dynamic friction coefficient and static friction coefficient is as described in the testing example, which will be described later.

### 1. Elements

### 1-1. Base Material

The base material 11 may be appropriately selected from those suitable for a touch panel on which a touch pen is used, and it may be preferred to select a plastic film having a good affinity with the writing feel improving layer 12. Note, however, that the base material 11 may be glass.

Examples of such a plastic film include films of polyesters such as polyethylene terephthalate, polybutylene terephthalate, and polyethylene naphthalate, polyolefin films such as a polyethylene film and a polypropylene film, cellophane, a diacetyl cellulose film, a triacetyl cellulose film, an acetyl cellulose butyrate film, a polyvinyl chloride film, a polyvinylidene chloride film, a polyvinyl alcohol film, an ethylene-vinyl acetate copolymer film, a polystyrene film, a polycarbonate film, a polymethylpentene film, a polysulfone film, a polyether ether ketone film, a polyether sulfone film, a polyether imide film, a fluorine resin film, a polyamide film, an acrylic resin film, a polyurethane resin film, a norbornene-based polymer film, a cyclic olefin-based polymer film, a cyclic conjugated diene-based polymer film, a vinyl alicyclic hydrocarbon polymer film, other appropriate plastic films, and laminated films thereof. Among these, the polyethylene terephthalate film, polycarbonate film, norbornene-based polymer film, and the like may be preferred because they can well maintain the writing feel with a touch pen in combination with the previously described writing feel improving layer 12, and the polyethylene terephthalate film may be particularly preferred.

For the purpose of improving the interfacial adhesion between the above base material 11 and a layer provided on the surface of the base material 11 (such as the writing feel improving layer 12 or a pressure sensitive adhesive layer to be described later), if desired, one surface or both surfaces of the base material 11 can be subjected to surface treatment, such as by primer treatment, an oxidation method, or a roughening method. Examples of the oxidation method include corona discharge treatment, chromic acid treatment, flame treatment, hot-air treatment, and ozone/ultraviolet treatment. Examples of the roughening method include a sandblast method and a solvent treatment method. Any of these surface treatment methods may be appropriately selected in accordance with the type of the base material 11. As an example, it may be preferred to use a plastic film, in particular a polyethylene terephthalate film, on which an easy-adhesion layer is formed by the primer treatment.

The thickness of the base material 11 is not particularly limited, but in consideration of the use for a touch panel, the thickness may be preferably 25 μm or more, particularly preferably 38 μm or more, and further preferably 50 μm or more. From another aspect, the thickness of the base material 11 may be preferably 500 μm or less, particularly preferably 400 μm or less, and further preferably 300 μm or less.

### 1-2. Writing Feel Improving Layer

### (1) Material for Writing Feel Improving Layer

The writing feel improving layer 12 of the writing feel improving sheet 1 in the present embodiment may be formed of any material, provided that the writing feel improving layer 12 contains an antiviral agent and satisfies the previously described writing feel physical properties, but the writing feel improving layer 12 may be preferably formed by curing a coating composition C, which will be described below. According to the coating composition C, the writing feel improving layer 12 satisfying the above writing feel physical properties may be easily formed, and the writing feel improving layer 12 having antiviral properties can be formed.

The coating composition C in the present embodiment may preferably contain a curable component and an antiviral agent.

### (1-1) Curable Component

The curable component may be a component that is cured by a trigger such as active energy rays or heat, and examples of the curable component include an active energy ray-curable component and a thermosetting component. In the present embodiment, it may be preferred to use the active energy ray-curable component from the viewpoint of the hardness of the writing feel improving layer 12 formed, the heat resistance of the base material 11 (plastic film), and the like.

The active energy ray-curable component may be preferably a component that can be cured by irradiation with active energy rays and does not inhibit the antiviral properties obtained by the antiviral agent.

Specific examples of the active energy ray-curable component preferably include polyfunctional (meth)acrylate-based monomer, (meth)acrylate-based prepolymer, and active energy ray-curable polymer. Among these, the polyfunctional (meth)acrylate-based monomer or the (meth)acrylate-based prepolymer may be more preferred. The polyfunctional (meth)acrylate-based monomer and the (meth)acrylate-based prepolymer may each be used alone or both may also be used in combination. As used in the present specification, the (meth)acrylate refers to both an acrylate and a methacrylate. The same applies to other similar terms.

Examples of the polyfunctional (meth)acrylate-based monomer include 1,4-butanediol di(meth)acrylate, 1,6-hexanediol di(meth)acrylate, neopentyl glycol di(meth)acrylate, polyethylene glycol di(meth)acrylate, hydroxypivalic acid neopentyl glycol di(meth)acrylate, dicyclopentanyl di(meth)acrylate, caprolactone-modified dicyclopentenyl di(meth)acrylate, ethylene oxide-modified phosphoric acid di(meth)acrylate, allylated cyclohexyl di(meth)acrylate, isocyanurate di(meth)acrylate, trimethylol propane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, tris(acryloxyethyl)isocyanurate, propionic acid-modified dipentaerythritol penta(meth)acrylate, dipentaerythritol hexa(meth)acrylate, ethylene oxide-modified dipentaerythritol hexa(meth)acrylate, caprolactone-modified dipentaerythritol hexa(meth)acrylate, and other appropriate polyfunctional (meth)acrylates. These may each be used alone or two or more types may also be used in combination.

Examples of the (meth)acrylate-based prepolymer include polyester acrylate-based, epoxy acrylate-based, urethane acrylate-based, and polyol acrylate-based prepolymers.

The polyester acrylate-based prepolymer can be obtained, for example, through preparing a polyester oligomer having hydroxyl groups at both ends, which is obtained by condensation of a polycarboxylic acid and a polyalcohol, and esterifying the hydroxyl groups of the polyester oligomer with (meth)acrylic acid, or through preparing an oligomer obtained by adding an alkylene oxide to a polycarboxylic acid and esterifying the hydroxyl group at an end of the oligomer with (meth)acrylic acid.

The epoxy acrylate-based prepolymer can be obtained, for example, through reacting (meth)acrylic acid with the oxirane ring of a relatively low-molecular-weight bisphenol-type epoxy resin or novolak-type epoxy resin to esterify it.

The urethane acrylate-based prepolymer can be obtained, for example, through preparing a polyurethane oligomer obtained by a reaction between a polyether polyol or a polyester polyol and a polyisocyanate and esterifying the polyurethane oligomer with (meth)acrylic acid.

The polyol acrylate-based prepolymer can be obtained, for example, through esterifying a hydroxyl group of a polyether polyol with (meth)acrylic acid.

The above prepolymers may each be used alone or two or more types may also be used in combination.

### (1-2) Antiviral Agent

It suffices that the antiviral agent is any one capable of inactivating the targeted virus. The targeted virus may be a virus having an envelope or a virus having no envelope. Examples of the virus having an envelope include influenza virus, SARS-CoV-2, herpes virus, rubella virus, hepatitis B virus, hepatitis C virus, and AIDS virus. Examples of the virus having no envelope include norovirus, rotavirus, poliovirus, adenovirus, and feline calicivirus.

The antiviral agent may be preferably in the form of fine particles, and the previously described writing feel physical properties can thereby be easily achieved due to the contribution of the antiviral agent. Examples of the antiviral agent include an inorganic-based antiviral agent and an organic-based antiviral agent, but an organic-based antiviral agent, particularly an organic-based antiviral agent in the form of fine particles, may be preferably used because the previously described writing feel physical properties can be easily achieved. One type of the antiviral agent may be used alone or two or more types may also be used in combination.

Examples of the organic-based antiviral agent include those composed of an antiviral group and a resin base substance. Specific examples of the antiviral group include an anionic group, a cationic group, and an ether group. Examples of the anionic group include a sulfonic acid group, a phosphoric acid group, a carboxyl group, a hydroxyl group, and a nitro group. Examples of the cationic group include a quaternary amino group. Examples of the ether group include alkyl ether groups such as an ethyl ether group and a propyl ether group.

The resin base substance may be preferably a polymer of a monomer having a vinyl group. Examples of the monomer having a vinyl group include styrene, (meth)acrylic acid ester, divinylbenzene, and trivinylbenzene. From the viewpoint of improving the degree of cross-linking of the resin base substance, a polyfunctional monomer or the like may be contained as a monomer constituent component. By polymerizing the monomers having such a vinyl group to form a three-dimensional network structure, the previously described form of fine particles or the like can be obtained.

The average particle diameter of the antiviral agent in the form of fine particles may be preferably 0.5 μm or more, more preferably 1.0 μm or more, particularly preferably 1.5 μm or more, and further preferably 2.5 μm or more. From another aspect, the average particle diameter of the antiviral agent may be preferably 10 μm or less, more preferably 8.0 μm or less, particularly preferably 6.0 μm or less, and further preferably 5.0 μm or less. This allows the antiviral properties to be easily exhibited well and also allows the previously described writing feel physical properties to be more easily satisfied. The average particle diameter of the antiviral agent is to be measured by a laser diffraction method.

The content of the antiviral agent in the writing feel improving layer 12 (coating composition C) may be preferably 1.0 mass % or more, more preferably 3.0 mass % or more, particularly preferably 5.0 mass % or more, and further preferably 9 mass % or more. From another aspect, the content of the antiviral agent may be preferably 40 mass % or less, more preferably 30 mass % or less, particularly preferably 25 mass % or less, and further preferably 20 mass % or less. When the content of the antiviral agent falls within the above range, suitable antiviral properties can be exhibited, and the previously described writing feel physical properties can be more easily satisfied.

The content of the antiviral agent with respect to 100 mass parts of the curable component may be preferably 1.0 mass parts or more, more preferably 3.0 mass parts or more, particularly preferably 5.0 mass parts or more, and further preferably 10 mass parts or more. From another aspect, the content of the antiviral agent with respect to 100 mass parts of the curable component may be preferably 40 mass parts or less, more preferably 30 mass parts or less, particularly preferably 25 mass parts or less, and further preferably 20 mass parts or less. When the content of the antiviral agent falls within the above range, suitable antiviral properties can be exhibited, and the previously described writing feel physical properties can be more easily satisfied.

### (1-3) Filler

It is also preferred that the coating composition C should contain a filler other than the antiviral agent. This allows the previously described writing feel physical properties to be more easily satisfied and also allows the writing feel improving layer 12 to be imparted with antiglare properties. Examples of the filler include inorganic-based fine particles such as silica, calcium carbonate, aluminum hydroxide, magnesium hydroxide, clay, talc, and titanium dioxide; organic-based fine particles such as acrylic resin, polystyrene resin, polyethylene resin, and epoxy resin; and fine particles composed of a silicon-containing compound having an inorganic and organic intermediate structure (e.g., Tospearl series available from Momentive Performance Materials Japan, which are fine particles of silicone resin). One type of the filler may be used alone or two or more types may also be used in combination.

Examples of the above fine particles composed of the acrylic resin include a homopolymer of methyl methacrylate and a copolymer of methyl methacrylate and a monomer such as vinyl acetate, styrene, methyl acrylate, or ethyl (meth)acrylate.

The shape of the filler may be a definite shape such as a spherical shape or may also be an indefinite shape whose shape is not specified. From the viewpoint of improving the writing feel, it may be preferred to use inorganic-based fine particles having an indefinite shape (e.g., silica having an indefinite shape).

The average particle diameter of the filler may be more preferably 0.3 μm or more, particularly preferably 0.5 μm or more, and further preferably 1.0 μm or more. From another aspect, the average particle diameter of the filler may be preferably 10 μm or less, more preferably 8.0 μm or less, particularly preferably 5.0 μm or less, and further preferably 3.0 μm or less. When the average particle diameter of the filler falls within the above range, the previously described writing feel physical properties may be more easily satisfied, and the antiglare properties can be exhibited well. Moreover, inhibition of the antiviral action obtained by the antiviral agent can be suppressed. The average particle diameter of the filler is to be measured by a centrifugal sedimentation light transmission method.

The content of the filler in the writing feel improving layer 12 (coating composition C) may be preferably 1.0 mass parts or more, more preferably 3.0 mass parts or more, particularly preferably 5.0 mass parts or more, and further preferably 10 mass parts or more with respect to 100 mass parts of the curable component. From another aspect, the content may be preferably 60 mass parts or less, more preferably 40 mass parts or less, particularly preferably 30 mass parts or less, and further preferably 20 mass parts or less. When the content of the filler falls within the above range, the previously described writing feel physical properties may be more easily satisfied, and the antiglare properties can be exhibited well. Moreover, inhibition of the antiviral action obtained by the antiviral agent can be suppressed.

### (1-4) Sol Component

It is also preferred that the coating composition C should contain a sol component. Examples of the sol component include those in which fine particles are in the form of an organosol (colloidal). Examples of the fine particles include inorganic-based fine particles such as silica, which are used, for example, as an organosilica sol. The fine particles may be those in which functional groups such as a (meth)acryloyl group and a silanol group are bonded to the surface.

The average particle diameter of the fine particles as the sol component may be preferably less than 300 nm, more preferably 100 nm or less, particularly preferably 80 nm or less, and further preferably 40 nm or less. From another aspect, the average particle diameter may be preferably 1 nm or more, more preferably 4 nm or more, particularly preferably 8 nm or more, and further preferably 10 nm or more. When the average particle diameter falls within the above range, the previously described writing feel physical properties may be more easily satisfied. Moreover, inhibition of the antiviral action obtained by the antiviral agent can be suppressed. The average particle diameter of the above inorganic-based fine particles is to be measured by a centrifugal sedimentation light transmission method.

The content of the sol component in the writing feel improving layer 12 (coating composition C) may be preferably 1 mass part or more, more preferably 5 mass parts or more, particularly preferably 10 mass parts or more, and further preferably 20 mass parts or more with respect to 100 mass parts of the curable component. From another aspect, the content may be preferably 300 mass parts or less, more preferably 200 mass parts or less, particularly preferably 100 mass parts or less, and further preferably 50 mass parts or less. This allows the previously described writing feel physical properties to be more easily satisfied. Moreover, inhibition of the antiviral action obtained by the antiviral agent can be suppressed.

### (1-5) Photopolymerization Initiator

When ultraviolet rays are used to cure the above active energy ray-curable component, the coating composition C may preferably contain a photopolymerization initiator. When the coating composition C contains a photopolymerization initiator, the active energy ray-curable component can be efficiently polymerized, and the polymerization curing time and the irradiation amount of ultraviolet rays can be reduced.

Examples of such a photopolymerization initiator include benzoin, benzoin methyl ether, benzoin ethyl ether, benzoin isopropyl ether, benzoin-n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholino-propan-1-one, 4-(2-hydroxyethoxy)phenyl-2-(hydroxy-2-propyl)ketone, benzophenone, p-phenylbenzophenone, 4,4′-diethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, p-dimethylaminobenzoic ester, oligo[2-hydroxy-2-methyl-1[4-(1-methylvinyl)phenyl]propanone], and 2,4,6-trimethylbenzoyl-diphenyl-phosphine oxide. These may each be used alone or two or more types may also be used in combination.

The lower limit of the content of the photopolymerization initiator in the coating composition C may be preferably 0.01 mass parts or more, particularly preferably 0.1 mass parts or more, and further preferably 1 mass part or more with respect to 100 mass parts of the active energy ray-curable component. From another aspect, the upper limit of the content may be preferably 20 mass parts or less, particularly preferably 10 mass parts or less, and further preferably 5 mass parts or less.

### (1-6) Antifoulant

It is also preferred that the coating composition C according to the present embodiment should contain an antifoulant. This allows the formed writing feel improving layer 12 to be excellent in the antifouling properties and it is possible to prevent fingerprints and stains from adhering to the writing feel improving layer 12.

Examples of the antifoulant include a silicone-based antifoulant, a fluorine-based antifoulant, and an acrylic-based antifoulant. Among these, the fluorine-based antifoulant may be preferably used from the viewpoint of preventing the adhesion of fingerprints and stains. Preferred examples of the fluorine-based antifoulant include a fluorine-based resin having a (meth)acrylate group that is polymerizable with a polyfunctional (meth)acrylate-based monomer or a (meth)acrylate-based prepolymer as a binder resin.

The content of the antifoulant in the writing feel improving layer 12 (coating composition C) may be preferably 0.01 mass parts or more, particularly preferably 0.1 mass parts or more, and further preferably 0.5 mass parts or more with respect to 100 mass parts of the curable component. From another aspect, the content may be preferably 30 mass parts or less, particularly preferably 10 mass parts or less, and further preferably 5 mass parts or less.

### (1-7) Leveling Agent

It is also preferred that the coating composition C according to the present embodiment should contain a leveling agent. This allows the formed writing feel improving layer 12 to have a uniform film thickness without streaky defects, unevenness, or the like and exhibit excellent optical properties and appearance.

Examples of the leveling agent include a silicone-based leveling agent, a fluorine-based leveling agent, an acrylic-based leveling agent, and a vinyl-based leveling agent, among which the silicone-based leveling agent or fluorine-based leveling agent may be preferred from the viewpoint of leveling properties and compatibility with other components. One type of the leveling agent may be used alone or two or more types may also be used in combination.

The leveling agent may be modified or unmodified. The leveling agent may have a reactive group or may not have a reactive group.

The content of the leveling agent in the writing feel improving layer 12 (coating composition C) may be preferably 0.01 mass parts or more, particularly preferably 0.05 mass parts or more, and further preferably 0.1 mass parts or more with respect to 100 mass parts of the curable component. From another aspect, the content may be preferably 5.0 mass parts or less, particularly preferably 3.0 mass parts or less, and further preferably 1.0 mass parts or less.

### (1-8) Other Components

The coating composition C in the present embodiment may contain various additives in addition to the above components. Examples of such additives include a dispersant, an ultraviolet absorber, an antioxidant, a light stabilizer, an antistatic, a silane coupling agent, an antiaging agent, a thermal polymerization inhibitor, a colorant, a surfactant, a storage stabilizer, a plasticizer, a glidant, and an antifoam.

### (2) Thickness

The thickness of the writing feel improving layer 12 may be preferably 0.5 μm or more, more preferably 1.0 μm or more, particularly preferably 1.5 μm or more, and further preferably 2.0 μm or more. The previously described writing feel physical properties may be easily satisfied, and the antiviral properties can be exhibited well. From another aspect, the thickness of the writing feel improving layer 12 may be preferably 20 μm or less, more preferably 15 μm or less, particularly preferably 10 μm or less, and further preferably 5.0 μm or less. This allows the previously described writing feel physical properties to be easily satisfied.

### 1-3. Other Configurations

The writing feel improving sheet 1 according to the present embodiment may include a pressure sensitive adhesive layer on the surface side of the base material 11 opposite to the writing feel improving layer 12. The pressure sensitive adhesive constituting the pressure sensitive adhesive layer is not particularly limited, and a known pressure sensitive adhesive can be used, such as an acrylic-based pressure sensitive adhesive, a rubber-based pressure sensitive adhesive, or a silicone-based pressure sensitive adhesive. It may be preferred to use a pressure sensitive adhesive having predetermined transparency.

When the writing feel improving sheet 1 according to the present embodiment includes the above-described pressure sensitive adhesive layer, a release film may be laminated on the surface of the pressure sensitive adhesive layer opposite to the base material 11 in the writing feel improving sheet 1 according to the present embodiment. The release film is not particularly limited, provided that it has desired release properties on the release surface (surface in contact with the pressure sensitive adhesive layer), and a known release film can be used, such as a resin film whose one surface is release-treated with a release agent.

### 2. Production Method for Writing Feel Improving Sheet

The writing feel improving sheet 1 according to the present embodiment can be produced through coating the base material 11 with a coating liquid that contains a coating composition for the writing feel improving layer 12, preferably the coating composition C, and a solvent if desired and curing the coating liquid to form the writing feel improving layer 12.

The solvent can be used for improvement of coating properties, adjustment of viscosity, adjustment of solid content concentration, and the like. Such a solvent can be used without particular limitation, provided that each component can be dissolved or dispersed in the solvent. Specific examples of the solvent include alcohols such as methanol, ethanol, isopropanol, butanol, and octanol; ketones such as acetone, methyl ethyl ketone, methyl isobutyl ketone, and cyclohexanone; esters such as ethyl acetate, butyl acetate, ethyl lactate, and γ-butyrolactone; ethers such as ethylene glycol monomethyl ether (methyl cellosolve), ethylene glycol monoethyl ether (ethyl cellosolve), diethylene glycol monobutyl ether (butyl cellosolve), and propylene glycol monomethyl ether; aromatic hydrocarbons such as benzene, toluene, and xylene; and amides such as dimethylformamide, dimethylacetamide, and N-methylpyrrolidone.

The coating with the coating liquid of the coating composition may be performed by using an ordinary method, such as a bar coating method, a knife coating method, a roll coating method, a blade coating method, a die coating method, or a gravure coating method. After the coating with the coating liquid of the coating composition, it may be preferred to dry the coating film at 40° C. to 120° C. for about 30 seconds to 5 minutes.

Here, when the coating composition contains a leveling agent, the coating film obtained by coating with the coating composition has no streaky defects or unevenness, and therefore the writing feel improving layer 12 having a uniform film thickness and excellent appearance can be formed.

When the coating composition is active energy ray curable as in the coating composition C, the coating composition may be cured by irradiating the coating film of the coating composition with active energy rays such as ultraviolet rays and electron rays. Irradiation with ultraviolet rays can be performed by using a high-pressure mercury lamp, a fusion H lamp, a xenon lamp, or the like, and the irradiance level of ultraviolet rays may be preferably about 50 to 1,000 mW/cm² as the illuminance and about 50 to 1,000 mJ/cm² as the light amount. On the other hand, irradiation with electron rays can be performed by using an electron ray accelerator or the like, and the irradiance level of electron rays may be preferably about 10 to 1,000 krad.

Irradiation of the coating film of the above coating composition with active energy rays can be performed in an air atmosphere or an inert gas atmosphere. Depending on the type of the active energy ray-curable component, the coating composition can be cured well without being affected by oxygen inhibition by performing the active energy ray irradiation in an inert gas atmosphere.

Examples of the inert gas include nitrogen, argon, and helium, among which nitrogen and argon may be preferred and nitrogen may be particularly preferred. The oxygen concentration in the inert gas atmosphere may be preferably 5% or less, more preferably 3% or less, and particularly preferably 2% or less.

### 3. Physical Properties of Writing Feel Improving Sheet, Etc.

### (1) Haze Value

The haze value of the writing feel improving sheet 1 according to the present embodiment may be preferably 5.0% or more, more preferably 8.0% or more, particularly preferably 10% or more, and further preferably 15% or more. This can impart good antiglare properties. On the other hand, from the viewpoint of visibility of images/videos, the haze value may be preferably 60% or less, more preferably 55% or less, particularly preferably 50% or less, and further preferably 45% or less. A method of measuring the haze value is as described in the testing example, which will be described later.

### (2) Total Luminous Transmittance

The total luminous transmittance of the writing feel improving sheet 1 according to the present embodiment may be preferably 80% or more, more preferably 85% or more, and particularly preferably 90% or more. When the total luminous transmittance is the above value, the transparency is very high, and the writing feel improving sheet 1 is particularly suitable for optical applications (for display bodies). A method of measuring the total luminous transmittance is as described in the testing example, which will be described later.

### (3) Image Clarity

The total value of image clarity (%) for optical combs of 0.125 mm, 0.25 mm, 0.5 mm, 1.0 mm, and 2.0 mm as measured for the writing feel improving sheet 1 in accordance with JIS K7374: 2007 may be preferably 30 or more, more preferably 50 or more, particularly preferably 100 or more, and further preferably 150 or more. This allows the visibility of images/videos on a display to be satisfactory.

On the other hand, the above total value of image clarity (%) may be preferably 480 or less, more preferably 450 or less, particularly preferably 400 or less, and further preferably 300 or less. This allows the writing feel physical properties to be exhibited well while the visibility of images/videos on a display is maintained well.

Here, the image clarity is obtained by measuring the light amount of parallel light rays transmitted through a test piece through an optical comb having transmitting portions and light-shielding portions. The smaller the width (comb width) of the transmitting portions and light-shielding portions in the optical comb, the higher definition the image clarity has. The image clarity is measured in accordance with a transmission method of JIS K7374: 2007. A specific measurement method is as described in the testing example, which will be described later.

### (4) 60° Specular Gloss

In the writing feel improving sheet 1 according to the present embodiment, the 60° specular gloss (gloss value) of the surface of the writing feel improving layer 12 with which a touch pen is brought into contact may be preferably 30% or more, more preferably 50% or more, and particularly preferably 70% or more from the viewpoint of preventing discoloration. From another aspect, the 60° specular gloss of the writing feel improving sheet 1 may be preferably 150% or less, particularly preferably 110% or less, and further preferably 90% or less from the viewpoint of ease of satisfying the writing feel physical properties. A method of measuring the 60° specular gloss in the present specification is as described in the testing example, which will be described later.

### (5) Pencil Hardness

The pencil hardness of the surface of the writing feel improving sheet 1 according to the present embodiment may be preferably F or more, particularly preferably H or more, and further preferably 2H or more. When the writing feel improving layer 12 has such pencil hardness, the surface of the writing feel improving sheet 1 has sufficient hardness and can exhibit excellent scratch resistance. The upper limit of the above pencil hardness is not particularly limited, but may be preferably 6H or less. A method of measuring the pencil hardness is as described in the testing example, which will be described later.

### 4. Use of Writing Feel Improving Sheet

The writing feel improving sheet 1 according to the present embodiment can be used as a sheet that constitutes the outermost layer of a touch panel (image display device with position detection function) on which a touch pen is used. Specifically, the writing feel improving sheet 1 may be preferably used by being laminated on the cover material of a display body module such as a liquid crystal (LCD) module, a light emitting diode (LED) module, or an organic electroluminescence (organic EL) module or the cover material of a touch panel having a touch sensor or the like. Lamination of the writing feel improving sheet 1 on the cover material may be preferably performed by attaching the writing feel improving sheet 1 to the cover material via the previously described pressure sensitive adhesive layer.

The touch pen used for the writing feel improving sheet 1 according to the present embodiment is not particularly limited, and a conventionally known one can be used. As the touch pen, for example, a touch pen having a polyacetal pen tip, a touch pen having a hard felt pen tip, a touch pen having an elastomer pen tip, or the like can be used. The shape of the pen tip of the touch pen is not particularly limited, and can be appropriately selected from a disk shape, a circular shape, a polygonal shape, and the like, but from the viewpoint that the feeling of vibration when writing with a ballpoint pen can be obtained, a circular shape may be preferred. When the shape of the pen tip of a touch pen is a circular shape, the diameter of the pen tip may be preferably 0.1 mm or more, particularly preferably 0.2 mm or more, and further preferably 0.3 mm or more. From another aspect, the above diameter may be preferably 5 mm or less, particularly preferably 2 mm or less, and further preferably 1 mm or less.

5. Touch Panel with Writing Feel Improving Sheet

By laminating the writing feel improving sheet according to the embodiment described above on a touch panel, the touch panel with the writing feel improving sheet (including the concept of a display body provided with a touch panel member) can be obtained. Specifically, the touch panel with the writing feel improving sheet may include a writing feel improving sheet having a touch pen contact surface with which a touch pen is brought into contact and a touch panel and may be configured such that the surface side of the writing feel improving sheet opposite to the above touch pen contact surface is laminated on the display surface side of the touch panel. The writing feel improving sheet may be laminated directly on the display surface of the touch panel or may also be laminated on the display surface side of the touch panel via one or more other members or layers.

The type and adopted scheme of the above touch panel are not particularly limited, and for example, a touch panel of a capacitive type, an electromagnetic induction type, a resistive film type, a surface acoustic wave type (ultrasonic type), an infrared type, or other similar type can be used. Among these, a tough panel of capacitive type may be preferred from the viewpoint of easily reproducing an excellent writing feel, and when considering the reproducibility of characters and the like with a touch pen, a touch panel of capacitive type that also serves as a touch panel of electromagnetic induction type may be particularly preferred. The specific configuration or the like of the capacitive and electromagnetic induction type touch panel is not particularly limited, and conventionally known ones can be used.

It should be appreciated that the embodiments heretofore explained are described to facilitate understanding of the present invention and are not described to limit the present invention. It is therefore intended that the elements disclosed in the above embodiments include all design changes and equivalents to fall within the technical scope of the present invention.

For example, one or more other layers may be interposed between the base material 11 and the writing feel improving layer 12 in the writing feel improving sheet 1. Additionally or alternatively, one or more other layers such as a hard coat layer may be provided on the surface of the base material 11 opposite to the writing feel improving layer 12.

### EXAMPLES

Hereinafter, the present invention will be described further specifically with reference to examples, etc., but the scope of the present invention is not limited to these examples, etc.

### Example 1

The coating liquid of a coating composition was obtained through mixing 100 mass parts of dipentaerythritol hexaacrylate as the active energy ray-curable component, 30 mass parts (representing a solid content equivalent, the same applies to other components, hereinafter) of organosilica sol (available from Nissan Chemical Corporation, product name “MIBK-ST,” average particle diameter of 10 nm) as the sol component, 10 mass parts of anion-based organic filler (A1; available from SEKISUI CHEMICAL CO., LTD., product name “Virutaker VM,” average particle diameter of 3.0 μm) as the antiviral agent, 5.0 mass parts of 1-hydroxycyclohexylphenyl ketone as the photopolymerization initiator, 0.5 mass parts of fluorine-based resin (available from DIC, product name “Megaface RS-90”) as the antifoulant, and 0.2 mass parts of polydimethylsiloxane (available from Toray Dow Corning, product name “SH28”) as the silicone-based leveling agent in propylene glycol monomethyl ether. The coating composition of this system (the content of the antiviral agent may be different) is denoted by “C1” in Table 1.

A polyester film with an easy-adhesion layer (available from TOYOBO CO., LTD., product name “COSMOSHINE A4300,” thickness: 125 μm) was prepared as the base material, and the easy adhesion layer side was coated with the coating liquid of the coating composition obtained above, which was dried at 70° C. for 1 minute.

Then, in a nitrogen atmosphere, a writing feel improving layer having a thickness of 5.0 μm was formed on the base material by being irradiated with ultraviolet rays under the following conditions by using an ultraviolet irradiation device (available from EYE GRAPHICS CO., LTD., product name “EYE GRANDAGE ECS-401GX”).

### <Ultraviolet Irradiation Conditions>

Light source: High-pressure mercury lamp
Lamp power: 2 kW
Conveyor speed: 4.23 m/min
Illuminance: 300 mW/cm²
Light amount: 250 mJ/cm²

### Examples 2 to 4

Writing feel improving sheets were produced in the same manner as in Example 1 except that the type and compounding amount of the antiviral agent were as listed in Table 1.

### Example 5

The coating liquid of a coating composition was obtained through mixing 100 mass parts of dipentaerythritol hexaacrylate as the active energy ray-curable component, 40 mass parts of organosilica sol (available from Nissan Chemical Corporation, product name “MIBK-ST,” average particle diameter of 10 nm) as the sol component, 20 mass parts of silica fine particles having an indefinite shape (average particle diameter of 1.5 μm) as the filler, 10 mass parts of anion-based organic filler (A1; available from SEKISUI CHEMICAL CO., LTD., product name “Virutaker VM,” average particle diameter of 3.0 μm) as the antiviral agent, 5.0 mass parts of 1-hydroxycyclohexylphenyl ketone as the photopolymerization initiator, 1.0 mass parts of fluorine-based resin (available from DIC, product name “Megaface RS-90”) as the antifoulant, and 0.33 mass parts of polydimethylsiloxane (available from Toray Dow Corning, product name “SH28”) as the silicone-based leveling agent in propylene glycol monomethyl ether. The coating composition of this system is denoted by “C2” in Table 1.

A writing feel improving sheet was produced in the same manner as in Example 1 by using the obtained coating liquid of the coating composition.

### Comparative Example 1

The coating liquid of a coating composition was prepared with the same composition as in Example 5 except that the antiviral agent was not compounded. The coating composition of this system is denoted by “C3” in Table 1.

A writing feel improving sheet was produced in the same manner as in Example 1 by using the obtained coating liquid of the coating composition.

Details of the simplified names in Table 1 and additional information are as follows.

A1: Anion-based organic filler (available from SEKISUI CHEMICAL CO., LTD., product name “Virutaker VM,” average particle diameter of 3.0 μm)

A2: Ether-based organic filler (available from SEKISUI CHEMICAL CO., LTD., product name “Virutaker IV,” average particle diameter of 5.0 μm)

### Testing Example 1 (Measurement of Haze Value)

For the writing feel improving sheet produced in each of the Examples and Comparative Example, the haze value (%) was measured in accordance with JIS K7136: 2000 by using a haze meter (available from NIPPON DENSHOKU INDUSTRIES CO., LTD., product name “NDH-5000”). The results are listed in Table 2.

### Testing Example 2 (Measurement of Total Luminous Transmittance)

For the writing feel improving sheet produced in each of the Examples and Comparative Example, the total luminous transmittance (%) was measured in accordance with JIS K7361-1: 1997 by using a haze meter (available from NIPPON DENSHOKU INDUSTRIES CO., LTD., product name “NDH-5000”). The results are listed in Table 2.

### Testing Example 3 (Measurement of Image Clarity)

For the writing feel improving sheet produced in each of the Examples and Comparative Example, the image clarity (%) was measured for five types of optical combs (comb width: 0.125 mm, 0.25 mm, 0.5 mm, 1.0 mm, and 2.0 mm) in accordance with JIS K7374: 2007 by using an image clarity meter (available from Suga Test Instruments Co., Ltd., product name “ICM-10P”) and the total value thereof was calculated. The results are listed in Table 2.

### Testing Example 4 (Measurement of 60° Specular Gloss)

For the writing feel improving sheet produced in each of the Examples and Comparative Example, the 60° specular gloss (gloss value, %) was measured in accordance with JIS Z8741-1997 by using a gloss meter (available from NIPPON DENSHOKU INDUSTRIES CO., LTD.).

### Testing Example 5 (Evaluation of Antiglare Properties)

The surface on the base material side of the writing feel improving sheet produced in each of the Examples and Comparative Example was attached to one surface of a black plate (available from Yukou Trading Co., Ltd., product name “Acrylite”) via a double-sided pressure sensitive adhesive sheet. For the obtained laminate of the writing feel improving sheet and the black plate, a three-wavelength fluorescent lamp was lighted above the laminate, and the light was reflected from the writing feel improving sheet. The reflected light was visually observed, and the antiglare properties were evaluated in accordance with the following criteria. The results are listed in Table 2.

A: The outline of the fluorescent lamp visually recognized due to the reflection from the writing feel improving sheet was blurred.

B: The outline of the fluorescent lamp visually recognized due to the reflection from the writing feel improving sheet was slightly blurred.

C: The outline of the fluorescent lamp visually recognized due to the reflection from the writing feel improving sheet was not blurred.

### Testing Example 6 (Measurement of Pencil Hardness)

For the surface of the writing feel improving sheet produced in each of the Examples and Comparative Example, the pencil hardness was measured in accordance with JIS K5600. Specifically, on the surface of the writing feel improving sheet, a test was conducted to run pencils with different hardness of the pencil cores (available from MITSUBISHI PENCIL CO., LTD., product name “Mitsubishi Pencil Uni”) for a length of 7 mm or more with a load of 750 g and at an angle of 45°. The test was performed 5 times, and the hardness of the pencil core with which the film surface was not scratched 4 times or more was adopted as the pencil hardness on the surface of the writing feel improving sheet. The results are listed in Table 2.

### Testing Example 7 (Evaluation of Scratch Resistance)

The surface of the writing feel improving sheet produced in each of the Examples and Comparative Example was rubbed at a load of 250 g/cm² using #0000 steel wool to reciprocate it ten times within a length of 10 cm. The surface of the writing feel improving sheet was visually confirmed under a three-wavelength fluorescent lamp, and the scratch resistance was evaluated in accordance with the following criteria. The results are listed in Table 2.

A: There were no scratches.

B: There were scratches.

### Testing Example 8 (Friction Measurement)

The surface on the base material side of the writing feel improving sheet produced in each of the Examples and Comparative Example was attached to one surface of a glass plate (thickness: 1.2 mm) and this was used as the sample for measurement.

The above sample for measurement was set on a dedicated carriage for measurement of a static and dynamic friction tester (available from Trinity-Lab Inc., product name “Tribomaster TL201Ts”) so that the surface on the writing feel improving layer side (touch pen contact surface) would be on the upper side. The above dedicated carriage for measurement is configured to reciprocally move in a predetermined direction while keeping the setting surface of the above sample for measurement as the above static and dynamic friction tester is used.

Subsequently, a touch pen was fixed to the above static and dynamic friction tester so that the pen tip was brought into contact with the touch pen contact surface. At that time, the touch pen was inclined and fixed so that the angle formed between the touch pen and the touch pen contact surface was 45°. In addition, the direction of inclining the touch pen was inclined toward the moving direction side of the dedicated carriage for measurement and set parallel to the moving direction. The touch pen used was a hard felt core touch pen (available from Wacom Co., Ltd., product name “ACK-20003,” pen tip diameter: 0.5 mm).

Subsequently, in a state in which a load was applied to the touch pen under a pressurization condition of the load of 200 g, the above-described dedicated carriage for measurement was moved at a speed of 1.6 mm/sec thereby to slide the touch pen on the touch pen contact surface, and the static friction coefficient and the dynamic friction coefficient were derived based on the frictional force measured at that time. The results are listed in Table 2.

### Testing Example 9 (Pen Sliding Test)

For the writing feel improving layer surface of the sample for measurement obtained in Testing Example 8, the pen tip of a hard felt core touch pen (available from Wacom Co., Ltd., product name “ACK-20003,” pen tip diameter: 0.5 mm) was moved at a speed of 100 mm/min in any direction parallel to the surface of the writing feel improving sheet while bringing the pen tip into contact with the writing feel improving layer surface in the vertical direction (direction in which the axis of the pen tip was vertical to the surface of the writing feel improving layer) under a pressurization condition of a load of 3.92N. As in Testing Example 8, the above touch pen was attached to the dedicated carriage for measurement, and the dedicated carriage for measurement was moved to slide the touch pen on the writing feel improving layer.

The pen tip resistance force during movement was measured by using a universal tester (available from ORIENTEC CORPORATION, product name “Tensilon”), and a chart of movement distance (mm)-pen tip resistance force (mN) was obtained. Then, the obtained chart of movement distance (mm)-pen tip resistance force (mN) was Fourier transformed by software (available from Microsoft Corporation, product name “Excel” (registered trademark)), and a frequency (Hz)-amplitude (−) chart was obtained. From the frequency (Hz)-amplitude (−) chart, the number of peaks with an amplitude of 1.5 or more in a frequency range of 1 to 2 Hz was obtained. The results are listed in Table 2.

### Testing Example 10 (Sensory Evaluation of Writing Feel)

For the writing feel improving layer surface of the sample for measurement obtained in Testing Example 8, five panelists evaluated the following items of the writing feel through a predetermined writing operation in a simulated manner using a hard felt core touch pen (available from Wacom Co., Ltd., product name “ACK-20003,” pen tip diameter: 0.5 mm). Table 2 lists the evaluation results based on the evaluations made by the five panelists in accordance with the following criteria. The evaluation of each item of the writing feel was made with reference to the writing feel when writing on 5 sheets of paper (available from KOKUYO S&T Co., Ltd., product name “Campus Note A-ruled No-201A”) with a fountain pen (available from S.T. Dupont, product name “Line D 410674 Black Lacquer & Palladium”).

### (1) Feeling of Pen Tip Flow

The feeling of pen tip flow as the writing feel was evaluated in accordance with the following criteria.

A: All of the five panelists evaluated the feeling of pen tip flow equivalent to that when writing on paper.

B: Three or four of the five panelists evaluated the feeling of pen tip flow equivalent to that when writing on paper.

C: One or two of the five panelists evaluated the feeling of pen tip flow equivalent to that when writing on paper.

D: All of the five panelists evaluated that the pen tip flowed more than when writing on paper.

### (2) Feeling of Pen Tip Catch

The feeling of pen tip catch as the writing feel was evaluated in accordance with the following criteria.

A: All of the five panelists evaluated the feeling of pen tip catch equivalent to that when writing on paper.

B: Three or four of the five panelists evaluated the feeling of pen tip catch equivalent to that when writing on paper.

C: One or two of the five panelists evaluated the feeling of pen tip catch equivalent to that when writing on paper.

D: All of the five panelists evaluated that the pen tip was caught more than when writing on paper.

### (3) Scratching Sound

The scratching sound as the writing feel was evaluated in accordance with the following criteria.

A: All of the five panelists evaluated the scratching sound equivalent to that when writing on paper.

B: Three or four of the five panelists evaluated the scratching sound equivalent to that when writing on paper.

C: One or two of the five panelists evaluated the scratching sound equivalent to that when writing on paper.

D: All of the five panelists evaluated that the scratching sound when writing was insufficient.

### (4) Vibration

The vibration as the writing feel was evaluated in accordance with the following criteria.

A: All of the five panelists evaluated the vibration equivalent to that when writing on paper.

B: Three or four of the five panelists evaluated the vibration equivalent to that when writing on paper.

C: One or two of the five panelists evaluated the vibration equivalent to that when writing on paper.

D: All of the five panelists evaluated that the vibration when writing was insufficient.

### Testing Example 11 (Antiviral Properties Test)

Seasonal influenza A virus (with envelope) and feline calicivirus (without envelope) were adopted as the virus species for the antiviral properties test, which was conducted for the writing feel improving sheet produced in each of the Examples and Comparative Example in accordance with ISO 21702. Specifically, the test is as follows.

A virus suspension having a predetermined concentration was prepared by infecting host cells with a virus and culturing the cells. The writing feel improving sheet (5 cm×5 cm; measurement sample) produced in each of the Examples and Comparative Example was placed in a petri dish, and 0.4 mL of the virus suspension was placed on the surface of the writing feel improving sheet, which was covered with a polyethylene film (4 cm×4 cm) so that the virus suspension spread over the entire surface of the writing feel improving sheet.

After being stored in a constant temperature and humidity chamber for a predetermined time, the above petri dish was washed out with a SCDLP culture medium, and this washout liquid was diluted in a stepwise manner with an EMEM culture medium. Then, the viral infectivity of the diluted liquid was measured by a plaque measurement method. The viral infectivity was also measured in the same manner as above for a polyethylene film (5 cm×5 cm; standard sample) as substitute for the writing feel improving sheet. The difference between the measured viral infectivity of the standard sample and the viral infectivity of the measurement sample was calculated as a log value, and this was adopted as the antiviral activity value. The results are listed in Table 2.

TABLE 1

| | |
|---|---|
| Coating | |
| composition | Antiviral agent |

| | Type | Type | mass parts |
|---|---|---|---|
| Example 1 | C 1 | A 1 | 10 |
| Example 2 | | | 15 |
| Example 3 | | | 20 |
| Example 4 | | A 2 | 10 |
| Example 5 | C 2 | A 1 | 10 |
| Comparative Example 1 | C 3 | — | — |

TABLE 2

| | | | Image | | | | | |
|---|---|---|---|---|---|---|---|---|
| | | Total | clarity | 60° | | | | Evaluation of writing feel |
| | Haze | luminous | (total | specular | Evaluation | | Evaluation | Static |
| | value | transmittance | value of | gloss | of antiglare | Pencil | of scratch | friction |
| | (%) | (%) | 5 combs) | (%) | properties | hardness | resistance | coefficient |
| Example 1 | 19.9 | 90.8 | 277 | 88 | B | 2H | A | 0.15 |
| Example 2 | 38.7 | 90.0 | 120 | 48 | B | 2H | A | 0.20 |
| Example 3 | 56.4 | 89.3 | 35 | 21 | B | 2H | A | 0.27 |
| Example 4 | 27.5 | 90.6 | 215 | 62 | B | 2H | A | 0.35 |
| Example 5 | 29.3 | 90.5 | 271 | 81 | B | 2H | A | 0.20 |
| Comparative Example 1 | 15.1 | 90.5 | 308 | 59 | B | 2H | A | 0.21 |

| | Evaluation of writing feel | | | | | | Antiviral activity value | |
|---|---|---|---|---|---|---|---|---|
| | Dynamic | | Feeling | Feeling | | | Seasonal | |
| | friction | Number | of pen | of pen | Scratching | | influenza | Feline |
| | coefficient | of peaks | tip flow | tip catch | sound | Vibration | A virus | calicivirus |
| Example 1 | 0.15 | 7 | C | A | B | B | 2.3 | 2.1 |
| Example 2 | 0.18 | 9 | B | B | A | A | 2.5 | 2.4 |
| Example 3 | 0.24 | 8 | A | C | C | C | 2.3 | 2.6 |
| Example 4 | 0.26 | 9 | A | C | C | C | 2.2 | 0.3 |
| Example 5 | 0.17 | 8 | B | A | A | A | 2.2 | 2.2 |
| Comparative Example 1 | 0.19 | 8 | B | B | A | A | 0.2 | 0.1 |

As apparent from Table 2, the writing feel improving sheets produced in the Examples exhibited excellent antiviral properties against both the virus with envelope and the virus without envelope. Moreover, the writing feel improving sheets produced in the Examples were excellent in the writing feel with a touch pen.

### INDUSTRIAL APPLICABILITY

The writing feel improving sheet of the present invention may be preferably used as the outermost layer of a touch panel on which a touch pen is used.

### DESCRIPTION OF REFERENCE NUMERALS

1 writing feel improving sheet
   11 Base material
   12 Writing feel improving layer

1. A writing feel improving sheet comprising a base material and a writing feel improving layer with which a touch pen is brought into contact, wherein
the writing feel improving layer contains an antiviral agent, and
a number of peaks with an amplitude of 1.5 or more in a frequency range of 1 to 2 Hz is 3 or more and 20 or less, wherein the number of peaks is acquired from a frequency-amplitude chart that is obtained through bringing a pen tip of a hard felt core touch pen having a pen tip diameter of 0.5 mm into vertical contact with a surface of the writing feel improving layer with which the touch pen is brought into contact under a pressurization condition of a load of 3.92N, measuring a pen tip resistance force while moving the pen tip at a speed of 100 mm/min in any direction parallel to the surface of the writing feel improving layer to obtain a movement distance-pen tip resistance force chart, and Fourier transforming the obtained movement distance-pen tip resistance force chart to obtain the frequency-amplitude chart.

2. The writing feel improving sheet according to claim 1, wherein a dynamic friction coefficient is 0.10 or more and 0.50 or less when a touch pen having a pen tip of 0.5 mm diameter is used to bring the pen tip into contact with the surface of the writing feel improving layer with which the touch pen is brought into contact and the touch pen is then linearly slid at a speed of 1.6 mm/sec while applying a load of 200 g to the touch pen and maintaining an angle formed between the touch pen and the surface of the writing feel improving layer at 45°.

3. The writing feel improving sheet according to claim 1, wherein a static friction coefficient is 0.10 or more and 0.50 or less when a touch pen having a pen tip of 0.5 mm diameter is used to bring the pen tip into contact with the surface of the writing feel improving layer with which the touch pen is brought into contact and the touch pen is then linearly slid at a speed of 1.6 mm/sec while applying a load of 200 g to the touch pen and maintaining an angle formed between the touch pen and the surface of the writing feel improving layer at 45°.

4. The writing feel improving sheet according to claim 1, wherein the writing feel improving layer is a layer formed by curing a coating composition that contains a curable component and the antiviral agent.

5. The writing feel improving sheet according to claim 1, wherein the antiviral agent is an organic-based filler.
